(19) United States
(12) Patent Application Publication
(10) Pub. No.: US 2019/0214818 A1
(43) Pub. Date: Jul. 11, 2019

(54) SYSTEM AND METHOD FOR MANAGEMENT AND DISAGGREGATION OF POWER CONSUMPTION DATA

(71) Applicant: FORESIGHT ENERGY LTD., Hod HaSharon (IL)

(72) Inventors: Evgeny FINKEL, Petah-Tikva (IL); Emek SADOT, Ram-On (IL); Sergei EDELSTEIN, Herzliya (IL)

(73) Assignee: FORESIGHT ENERGY LTD., Hod HaSharon (IL)

(21) Appl. No.: 16/310,452

(22) PCT Filed: Jun. 19, 2017
(86) PCT No.: PCT/IL2017/050680

§ 371 Date: Dec. 17, 2018

Related U.S. Application Data
(60) Provisional application No. 62/352,635, filed on Jun. 21, 2016.

(51) Int. Cl. H02J 3/00; G06Q 50/06

(52) U.S. Cl. CPC H02J 3/00; H02J 2003/007; H02J 2003/003; G06Q 50/06

(57) ABSTRACT

System and method of disaggregating power consumption data, the method including receiving power consumption data from at least one power consumption meter, wherein the received power consumption data corresponds to at least one consumer, determining power consumption patterns from the received power consumption data, performing disaggregation of the received power consumption data and identifying at least one base load value for at least one consumer based on the power consumption patterns, grouping consumers into energetically similar groups based on the disaggregation, and providing energy saving recommendations to at least one consumer based on the disaggregation and grouping data.

### FIELD OF THE INVENTION

The present invention relates to power consumption meters. More particularly, the present invention relates to systems and methods for management of power consumption data received from power consumption meters.

### BACKGROUND OF THE INVENTION

In recent years, power consumption data has become available to many power providers or power suppliers utilizing “smart” power consumption meters. A power provider may purchase a specific amount of electric power from at least one power producer (e.g. from power plants) to be distributed to consumers of electrical power. The power consumption meters are usually directly coupled to a consumer, for instance coupled to a power grid of a private household, such that the power provider may at any time retrieve data from the meters, for instance retrieve power consumption data via a communication network.

In AC circuits, the portion of power averaged over a complete cycle of the AC waveform, results in net transfer of energy in one direction and known as active power (sometimes also called real power). The portion of power due to stored energy, which returns to the source in each cycle, is known as reactive power. Some “smart” power consumption meters are capable of providing both active and reactive power data.

While a vast amount of power consumption data is available, there is still a need for a way to analyze all of this data, and also learn additional information about the power consumption.

### SUMMARY OF THE INVENTION

There is thus provided, in accordance with some embodiments of the invention, a method of forecasting power consumption, the method including receiving power consumption data from at least one power consumption meter, wherein the received power consumption data corresponds to at least one consumer, determining power consumption patterns from the received power consumption data, forecasting future behavior of power consumption for at least one consumer, based on historical power consumption data and the power consumption patterns, and determining energy saving recommendations to at least one consumer based on the forecasting.

In some embodiments, the energy saving recommendations may be compared with a control group. In some embodiments, feedback may be received from at least one user, and comparing the received feedback with the recommendation results. In some embodiments, consumers may be grouped into energetically similar groups (e.g., groups having similar power consumption) based on the power consumption patterns, wherein determining energy saving recommendations to at least one consumer is also based on the grouping data. In some embodiments, historical power consumption data may be stored, and the grouping data may be averaged.

In some embodiments, the energy saving recommendations may be compared with the received power consumption data. In some embodiments, at least one forecasting accuracy feedback loop may be performed. In some embodiments, the grouping may be carried out based on power consumption data. In some embodiments, the grouping may be carried out based on user data including at least one of geographical location, socio-economic status and weather conditions at the proximity of the user.

In some embodiments, energy saving recommendations may be based on at least one of weather conditions at the proximity of the user and calendrical data. In some embodiments, power consumption data may be calibrated with known electrical devices that consume power during known periods of time.

In accordance with some embodiments of the invention, a power consumption data analysis system may include at least one power consumption meter, electrically coupled to a power grid of a premises having at least one power consuming device of at least one consumer, and an analysis computerized device coupled to the at least one power consumption meter and configured to receive power consumption data corresponding to the at least one consumer, wherein the computerized device comprises a processor and a memory unit that is configured to store code to be processed by the processor. In some embodiments, code executed on the processor may be configured to allow at least one of determination of power consumption patterns, future behavior of power consumption, and recommendation of energy saving based on historical power consumption data and the power consumption patterns.

In some embodiments, the analysis computerized device may further include at least one database having information regarding at least one of: weather conditions, power consumption rates as provided to each consumer, and average power consumption values for a group of consumers in a predefined geographical area.

In some embodiments, the analysis computerized device may further include at least one database that is configured to store data corresponding to at least two consumers that are grouped. In some embodiments, the analysis computerized device may further include a communication module configured to allow communication between the at least one power consumption meter and the analysis computerized device.

In some embodiments, the communication between the at least one power consumption meter and the analysis computerized device may be at least partially wireless. In some embodiments, the system may further include a user interface module coupled to at least one consumer, wherein the user interface module may be configured to receive feedback from a consumer to be compared with recommendations provided by the processor.

In accordance with some embodiments of the invention, a method of disaggregating power consumption data is provided, and may include receiving power consumption data from at least one power consumption meter, wherein the received power consumption data corresponds to at least one consumer, determining power consumption patterns from the received power consumption data, performing disaggregation of the received power consumption data and identifying at least one base load value for at least one consumer based on the power consumption patterns, grouping consumers into energetically similar groups (e.g., groups having similar power consumption under similar conditions, such as similar weather etc.) based on the disaggregation, and providing energy saving recommendations to at least one consumer based on the disaggregation and grouping data.

In some embodiments, historical power consumption data may be stored, and the grouping data may be averaged. In some embodiments, the energy saving recommendations may be compared with a control group. In some embodiments, feedback may be received from at least one user, and the received feedback may be compared with the recommendation results.

In some embodiments, consumers may be grouped into energetically similar groups based on the power consumption patterns, wherein determining energy saving recommendations to at least one consumer may also be based on the grouping data. In some embodiments, the energy saving recommendations may be compared with the received power consumption data. In some embodiments, the disaggregation may be performed based on the type of the received power consumption data.

In some embodiments, the grouping may be carried out based on power consumption data and/or based on user data such as of geographical location, socio-economic status and weather conditions at the proximity of the user. In some embodiments, energy saving recommendations may be based on at least one of weather conditions at the proximity of the user and calendrical data. In some embodiments, power consumption data may be calibrated with known electrical devices that consume power during known periods of time.

According to some embodiments of the invention, a power consumption data analysis system may include at least one power consumption meter, electrically coupled to a power grid of a premises having at least one power consuming device of at least one consumer and an analysis computerized device coupled to the at least one power consumption meter and configured to receive power consumption data corresponding to the at least one consumer, wherein the computerized device may include a processor and a memory that is configured to store code to be processed by the processor. In some embodiments, code executed on the processor may be configured to allow determination of power consumption patterns, disaggregation of power consumption data received from the at least one power consumption meter, and recommendation of energy saving based at least on the disaggregation.

In some embodiments, the analysis computerized device may further include at least one database having information regarding at least one of: weather conditions, power consumption rates as provided to each consumer, and average power consumption values for a group of consumers in a predefined geographical area. In some embodiments, the analysis computerized device may further include at least one database that is configured to store data corresponding to at least two consumers that are grouped based at least on disaggregation results. In some embodiments, the system may further include a communication module configured to allow communication between the at least one power consumption meter and the analysis computerized device.

In some embodiments, the system may further include a user interface module coupled to at least one consumer, wherein the user interface module is configured to receive feedback from a user to be compared with recommendations provided by the processor. In some embodiments, the communication between the at least one power consumption meter and the analysis computerized device may be at least partially wireless.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a power consumption data analysis system, according to some embodiments of the invention;

FIG. 2A shows a flowchart of a method for power consumption data analysis, according to some embodiments of the invention;

FIG. 2B shows a flowchart of a method of disaggregating power consumption data, according to some embodiments of the invention;

FIG. 3 schematically illustrates a power consumption data analysis system with a predefined control group, according to some embodiments of the invention; and

FIG. 4 shows a block diagram for disaggregation determination, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

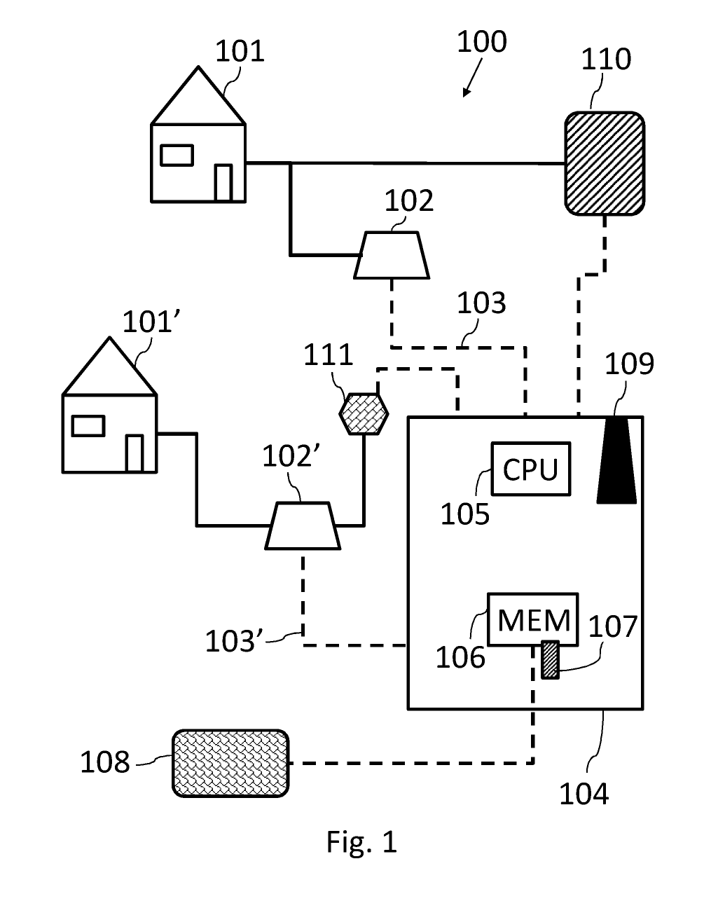

Reference is now made to FIG. 1, which schematically illustrates a power consumption data analysis system 100, according to some embodiments of the invention. Power consumption data analysis system 100 may comprise at least one “smart” power consumption meter 102, which measures power consumption of at least one consumer 101 that is coupled thereto. In some embodiments, power consumption meter 102 may be operably coupled to consumer 101 (e.g. coupled to a power grid of a private household), so as to allow monitoring of the power consumption of consumer 101. Power consumption meter 102 may also be configured to allow communication via network 103 with at least one analysis computerized device 104. In some embodiments, network 103 is a wireless network. In some embodiments, data analysis system 100 may further include a communication module 109 configured to allow communication between the at least one power consumption meter 102 and the analysis computerized device 104. In some embodiments, the communication between the at least one power consumption meter 102 and the analysis computerized device 104 may be at least partially wireless. In some embodiments, data analysis system 100 may further include a user interface module 111 coupled to at least one consumer 101, and configured to receive feedback from consumer 101 to be compared with recommendations provided by the processor 105.

In some embodiments, at least one power consumption meter 102 may be electrically coupled to a power grid of a premises having at least one power consuming device (e.g. a refrigerator) of at least one consumer 101. In some embodiments, the analysis computerized device 104 may be coupled to the at least one power consumption meter 102 and configured to receive and analyze power consumption data corresponding to the at least one consumer 101.

It should be appreciated that a plurality of different consumers may be similarly coupled to power consumption meters, wherein the aggregated data from all consumers may be analyzed by a central computerized device (such as analysis computerized device 104) with power consumption data transferred thereto via at least one network. It should be noted that in FIG. 1, only two consumers 101, 101′ are illustrated with corresponding meters 102, 102′ and networks 103, 103′ while any other number of consumers may also be possible. In some embodiments, different power consumption meters 102 may communicate with analysis computerized device 104 via different networks 103, for instance a wired network and a cellular network. In some embodiments, the number of consumers 101 may be determined, for example from data gathered from the meters 102.

It should be appreciated that analysis computerized device 104 may comprise a processor 105, for instance a central processing unit (CPU), that is configured to allow analyzing and processing of the aggregated data from all consumers. Analysis computerized device 104 may be further configured to allow disaggregation of the data from all consumers. Disintegration or disaggregation of power consumption data may refer to determination of separate power consumption tendencies from the total aggregated data. For example, disintegrating aggregated power consumption data into power consumption components (e.g., disaggregating overall power consumption of a household into consumption streams of separate subgroups of power consuming appliances), each characterized by baseline consumption and/or different time and/or weather dependency attributes.

In some embodiments, analysis computerized device 104 may also comprise a memory unit 106 that is configured to store executable code that may be processed by processor 105, and also store data in a first database 107 of average power consumption values. For example, such a first database 107 may include information on various electrical appliances and their corresponding energy consumption values (e.g. how much energy does a refrigerator of a certain model consume in an hour). In some embodiments, data for first database 107 may be retrieved with a calibration process, as further described hereinafter. In some embodiments, code executed on the processor 105 may be configured to allow at least one of determination of power consumption patterns, future behavior of power consumption, and recommendation of energy saving based on historical power consumption data and the power consumption patterns for at least one consumer 101.

According to some embodiments, memory unit 106 may be coupled to a second database 108, such that power consumption rates data may be communicated between memory unit 106 and second database 108. It should be noted that data from second database 108 may provide an indication for changes in rates during different hours, compared to actual consumption data from power consumption meters 102.

According to some embodiments, analysis computerized device 104 may be coupled to at least one power producer 110 (e.g. a power plant) that distributes power to consumers 101. A power provider may purchase a specific amount of electric power from at least one power producer 110 to be distributed to consumers 101. In some embodiments, analysis computerized device 104 may analyze power consumption data to create power consumption forecast and accordingly forecast required amount of electrical power to be purchased from at least one power producer 110.

Memory unit 106 may be or may include, for example, a Random Access Memory (RAM), a read only memory (ROM), a Dynamic RAM (DRAM), a Synchronous DRAM (SD-RAM), a double data rate (DDR) memory chip, a volatile memory such as but not limited to RAM, a non-volatile memory (NVM) such as but not limited to Flash memory, a cache memory, a buffer, a short term memory unit, a long term memory unit, or other suitable memory units or storage units. In some embodiments, memory 106 may be or may include a plurality of, possibly different memory units. Memory unit 106 may be a computer or processor non-transitory readable medium, or a computer non-transitory storage medium, e.g., a RAM.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium, computer-executable instructions and a controller. Such a non-transitory computer readable medium may be for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory unit 106 is a non-transitory machine-readable medium.

In some embodiments, memory unit 106 may include instructions that when executed by processor 105 may perform the methods described in more detail herein. It should be noted that the principles of the invention are implemented as hardware, firmware, software or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as a processing unit (“CPU”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit and/or display unit.

According to some embodiments, memory unit 106 may be further coupled to additional databases that may comprise additional information influencing the power consumption, for instance weather conditions database and/or meter that may provide information that may influence power consumption (e.g. on a cold day more heaters may be turned on). In some embodiments, the analysis computerized device 104 may further comprise at least one database having information regarding at least one of: weather conditions, power consumption rates as provided to each consumer, power production rates as provided by each power producer, calendrical information (e.g., dates for holidays that may indicate a different power consumption), and aggregated (e.g., averaged) power consumption values for a group of consumers in a predefined geographical area. In some embodiments, the analysis computerized device 104 may further comprise at least one database that is configured to store data corresponding to at least two consumers 101 that are grouped.

According to some embodiments, power consumption data analysis system 100 may utilize at least one of the following types of feedback loops in order to improve accuracy of the forecasting and/or disaggregation analysis:
Forecasting accuracy feedback, wherein forecast results may be compared with actual power consumption data and the disaggregation model may be tuned accordingly.
User and/or social network feedback, wherein energy saving recommendations may be presented to the user according to disaggregation results. It should be noted that reaction of the user (i.e. consumer) and/or group of energetically similar users may be used to improve accuracy of group disaggregation model, as further described hereinafter. In some embodiments, data for such a group may be stored on a dedicated database.
Supervised learning set feedback, wherein disaggregation results may be tested on a predetermined set of households for which historical labeled disaggregated data exists. It should be appreciated that disaggregation model parameters may be tuned to achieve better accuracy on such data.

In some embodiments, analyzing power consumption data for a certain facility (e.g., for a single building) may allow disaggregation of the power consumption to determine at least one of constant power consumption, dependency of power consumption on temperature and the like based on the power consumption pattern (e.g., constant or dynamic) and/or based on the historical power consumption data (e.g., compared to historical weather data).

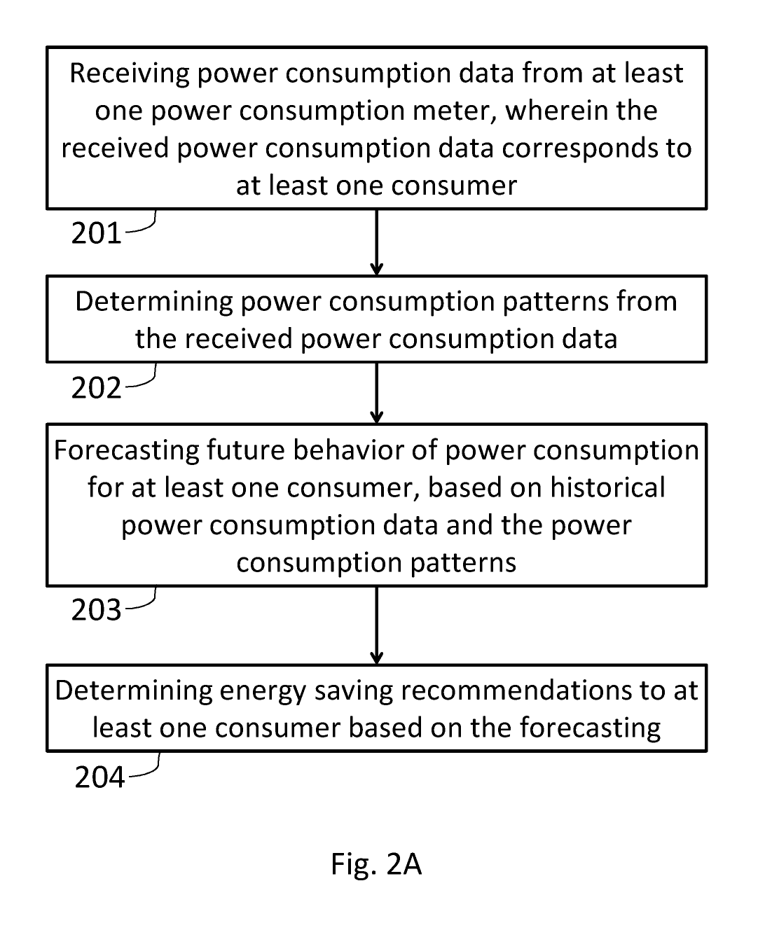

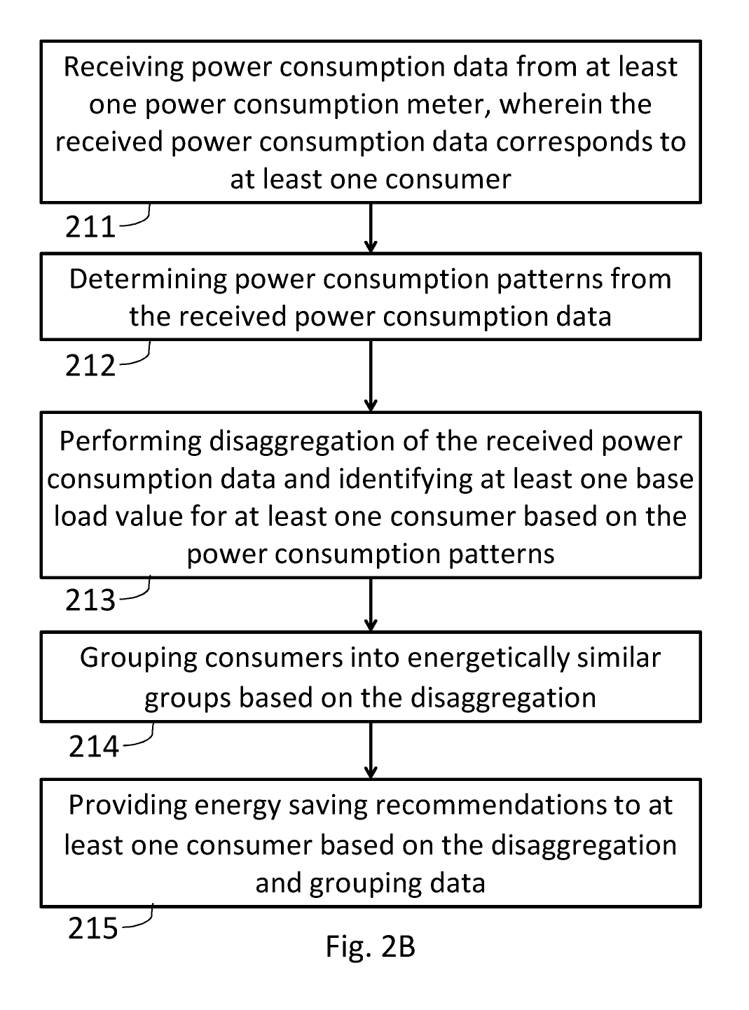

Reference is now made to FIGS. 2A-2B, which shows a flowchart of a method for power consumption data analysis, according to some embodiments of the invention. It should be appreciated that power consumption data analysis may comprise forecasting of future power consumption for each consumer and/or data disaggregation such that at least one electrical device that consumes power may be identified from the power consumption data. In some embodiments, identification of particular electrical devices may allow operation for improved performance and/or usage of the devices, as further described hereinafter.

FIG. 2A shows a flowchart of a method for power consumption data analysis. According to some embodiments, processor 105 may receive 201 (e.g. via the analysis computerized device 104) power consumption data from at least one power consumption meter 102 wherein the received power consumption data may correspond to at least one consumer, for instance receive power consumption data for a particular consumer 101. Processor 105 may determine 202 power consumption patterns (e.g., a pattern as a curve of power consumption over time) from the received power consumption data, for instance determine a reoccurring pattern of power consumption for a factory having high consumption in the mornings of weekdays and low consumption during the weekend. It should be noted that the power consumption patterns may be affected by external factors such as for example the weather.

Processor 105 may forecast 203 future behavior of power consumption for at least one consumer 101, based on historical power consumption data and the power consumption patterns. In some embodiments, processor 105 may determine 204 energy saving recommendations to at least one consumer 101 based on the forecasting 203, where each power consumption forecast may correspond to a different energy saving recommendation (e.g., recommend postponing usage of power consuming appliances to evening time if the forecasting indicates high usage during noon). In some embodiments, processor 105 may store historical power consumption data (e.g. store on memory unit 106), and average the grouping data. In some embodiments, processor 105 may compare the energy saving recommendations with the received power consumption data.

It should be noted that accurate forecasting and/or energy saving recommendations may allow purchasing (e.g. by a power provider) the optimal amount of power from a power producer 110 so as to distribute (e.g. by a power provider) the amount of electrical power to be consumed by consumers 101. Thus, energy may be saved since the purchased amount of electrical power, to be distributed to consumers, may correspond to the forecasted amount of power to be consumed. For example, such forecasting may allow purchasing the optimal amount in advance and thereby reduce costs associated with buying and/or selling electrical energy on different intra-day and/or imbalanced rates.

In some embodiments, processor 105 may compare the energy saving recommendations with a control group (for example a group of geographically neighboring consumers). In some embodiments, processor 105 may group consumers into energetically similar groups based on the power consumption patterns, wherein determining energy saving recommendations to at least one consumer is also based on the grouping data. In some embodiments, the grouping may be carried out based on power consumption data, for instance grouping energetically similar consumers together. In some embodiments, the grouping may be carried out based on user data including at least one of geographical location, socio-economic status and weather conditions at the proximity of the user. In some embodiments, energy saving recommendations may be based on at least one of weather conditions at the proximity of the user and calendrical data. In some embodiments, weather conditions (e.g., temperature, daylight hours, etc.) at the proximity of the user may be gathered from a corresponding weather sensor such that historical weather data may be stored and compared to stored historical power consumption data such that energy saving recommendations may correspond to weather data, for instance recommend to turn off heaters in an office building during times when hot temperature is expected.

In some embodiments, energy saving recommendations may be based on number of daylight hours and/or power consumption rates (e.g. from second database 108) to allow optimization of power consumption. For example, recommend power amount corresponding to application of heaters during a particular night and/or recommend optimal temperature settings for heaters during a particular night.

In some embodiments, processor 105 may receive feedback from at least one user (e.g. via a user interface) and compare the received feedback with the recommendation results. In some embodiments, processor 105 may perform at least one forecasting accuracy feedback loop. In some embodiments, processor 105 may calibrate power consumption data with known electrical devices that consume power during known periods of time.

For example, a hair dresser may have working hours similar to other consumers in the same group (e.g. other hair dressers), so that a historical comparison may be carried out for the power consumption data so as to provide optimal energy saving recommendations. In some embodiments, different consumers may be grouped together based on a predetermined parameter, for example only when ambient temperature is above 6 degrees. In some embodiments, several analysis algorithms (e.g., the Hidden Markov Model) or other models may be employed to provide accurate forecasting and/or energy saving recommendations. Then the accuracy of these models may be compared to consumption data so as to assign a weight for each model and provide a final forecast based on weighted results. In some embodiments, the forecast may be compared to real data and the models may be modified accordingly.

According to some embodiments, prior to analyzing the power consumption data, a calibration process may be carried out. During calibration, an exemplary household may be set up with known electrical devices that consume power during known periods of time, such that different behaviors of power consumption may be translated into consumption of particular devices (for example a washing machine consuming a known amount of power while operating for a full cycle, e.g. operating for two hours).

FIG. 2B shows a flowchart of a method of disaggregating power consumption data. In some embodiments, disaggregation may include machine learning algorithms that receive calibration data on known power consumption of specific electrical devices and may analyze the data from the meters in order to identify the devices in use. It should be appreciated that other data may also be used for disaggregation, including weather data (e.g. on hot days more air-conditioners are operating) and calendar data, where people on national holiday for instance may use more electrical devices compared to weekdays where people are usually at work during the day.

In some embodiments, processor 105 may receive 211 power consumption data from at least one power consumption meter 102, wherein the received power consumption data corresponds to at least one consumer 101. In some embodiments, processor 105 may determine 212 power consumption patterns from the received power consumption data. In some embodiments, processor 105 may perform 213 disaggregation of the received power consumption data and identify at least one power consuming device in the premises of the at least one consumer 101 based on the power consumption patterns.

In some embodiments, processor 105 may group 214 consumers 101 into energetically similar groups based on the disaggregation if disaggregation creates a similar energetic value for such consumers (e.g., disaggregation indicating similar power consumption for restaurants having similar appliances in the facility and/or similar consumption patterns), and provide 215 energy saving recommendations to at least one consumer 101 based on the disaggregation and grouping data.

In some embodiments, each consumer may have a user profile indicating typical power consumption of that user. Thus, data received for that consumer may be compared to the user profile in order to detect changes. For example, a malfunction in a central heating system may cause significantly lower power consumption, and by analyzing the data from the meters the malfunction may be identified.

In some embodiments, power consumption may be monitored through predefined periods of time where minimal power consumption is expected, for instance at two o'clock in the morning the main device consuming electrical power should be the refrigerator such that the typical power consumption of the refrigerator may be determined for each consumer. Similarly, other devices may be similarly disaggregated using weather information, for instance comparing a day with regular temperature versus extra cold day that causes enhanced use of heaters.

In some embodiments, processor 105 may perform classification of the power consumption data, wherein a predetermined number of consumer devices (for instance five devices) may be provided as input to the classification algorithm such that different consumers may be grouped into energetically similar groups. It should be noted that grouping several consumers may allow higher accuracy in forecasting future behavior since a larger group of data may be available for analysis.

It should be appreciated that in an area having smart power consumption meters within a predetermined geographical zone, neighboring consumers may present similar power consumption behavior (e.g. for similar socio-economic families), such that these consumers may be grouped based on their power consumption, for instance grouped within a neighborhood or within a city. In some embodiments, the K-nearest method may be utilized for the classification process.

It should be appreciated that such grouping may also be performed based on socio-economic data, such as geographic area of property (e.g. smaller than 50 m², and/or between 50 m² and 100 m², and/or larger than 100 m²). In some embodiments, the size of electric sockets (e.g. 3×25 A, 1×40 A, etc.) may similarly allow grouping based on such connections. However, it should be noted that it may also be possible to group users by parameters that are unknown a priori, for instance heat sensitivity (e.g. with detection of heat radiating from a household), users waking up early to use electric devices, users not working on Thursdays, etc.

In some embodiments, classification may include building decision trees, for instance based on a predefined set of parameters or training data (e.g. C4.5 algorithm), for personal and group models, taking into account power consumption, socio-economic status and weather attributes. Thus, it may be possible to achieve clusters in which samples in the same group have maximal similarity, while the groups within the cluster are still very different. Such clustering may be initially performed for consumption patterns, and then for other attributes such as users (e.g. for similar socio-economic status). In some embodiments, users clustering may be performed by a combination of socio-economic status (e.g. location type such as apartment or a private home, geographical area, etc.), weather preferences (e.g. heat sensitive, cold sensitive) and previously calculated consumption patterns at specific times (e.g. high consumption on weekends). It should be noted that other types of attributes may also be taken into account, for instance behavioral attributes, similar electricity tariffs, similar activity during a particular time of the day, etc.

Once classification is performed, processor 105 may perform forecasting of future behavior for each group from the classification process. It should be appreciated that forecasting may predict future use and thus suit a specific recommendation to the consumer. Such recommendations may also be based on the classification and grouping.

For example, if local power rates and/or energy purchasing prices are lower during the night, the system may forecast which devices (e.g. washing machine) are to operate the following day and recommend to the consumer that the most energetically efficient process is to operate these devices during the night.

In some embodiments, unusual behavior of consumer's power consumption after disaggregation may provide an indication on theft of electrical power (e.g. by illegally connecting to a power grid) or a power outage in a certain area. This indication may allow the provider of electrical power to act accordingly and fix any problem that may arise with power consumption.

In some embodiments, the recommendation may provide an indication to the provider of electrical power on how much power needs to be purchased and/or manufactured in order to fulfill the demand of the consumers.

According to some embodiments, at least one of forecasting and providing recommendations to the consumer may be carried out by the processor. In some embodiments, the analysis computerizes device may further comprise and/or coupled to a recommendation engine that is capable of providing recommendations based on previous calculations.

It should be appreciated that such recommendations may allow at least one of the following: steeper learning curve (e.g. due to grouped users), inherent adaptability to changes in consumers household devices, and also learning of models on large datasets in a specific country (e.g. country with high availability of “smart” meters) may be used to form a basic disaggregation model for a new country.

According to some embodiments, disaggregation may be performed without prior knowledge of the consumers. A device consumption database may be used for initial estimation of power consumption (e.g. in a calibration process). For instance, device consuming above 4 kWh must be an electric vehicle. In another example, overall consumption of 2 kWh, independent of weather conditions, must be comprised of two refrigerators. In some embodiments, an initial disaggregation model may be obtained on previously recorded historical disaggregated datasets, wherein even if this model is not sufficiently accurate, it may be further improved by a feedback loop (e.g. as described above).

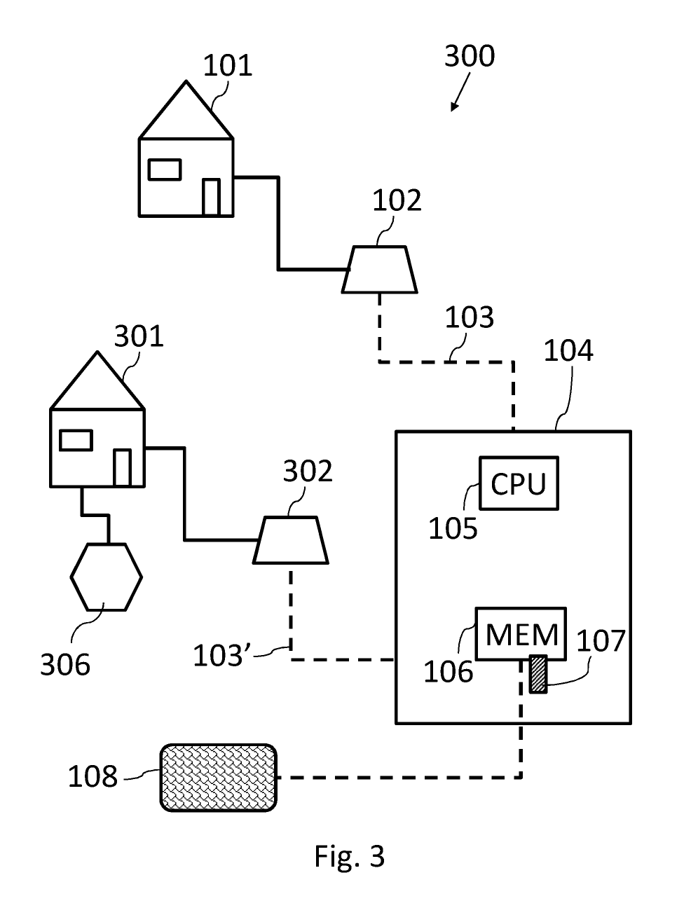

Reference is now made to FIG. 3, which schematically illustrates a power consumption data analysis system 300 with a predefined control group, according to some embodiments of the invention. A predefined control group may be set up at a chosen location, for instance choosing a particular consumer 301 to be the control group, wherein all power consuming devices are known as well as their power consumption (e.g. per hour) to be compared with data from meter 302. It should be noted that choosing a consumer as a control group may be based on an “energetically-similar” group formed during the classification, for instance in the same neighborhood. It should be appreciated that different types of meters may transmit different data types or formats (such that not all available information is received). For example, in some countries meters transmit both active power data (i.e. the net transfer of energy in one direction) and reactive power data (i.e. the portion of power due to stored energy), while in others only active power data may be transmitted. Reactive power data is dependent on specific devices available at home, for instance reactive power consumption pattern of a heating device may be totally different from a device having an electric engine. Therefore, when grouping power consumption situations, a combination of active and reactive parameters may be used (when available for a specific meter), resulting in more accurate disaggregation analysis. In some embodiments, different disaggregation methods may be used for different types of meters providing different types of data.

In some embodiments, a user interface module 306 may be coupled to control group 301 in order to receive feedback from the consumer in order to improve disaggregation results for the entire group. For instance, the consumer may provide feedback regarding the recommendations for energy saving, such that power consumption data analysis system 300 may learn if the recommendations in fact assist in saving energy.

According to some embodiments, results of supervised learning (e.g. on a limited set of households with known devices) may be performed on one of the members of an “energetically-similar” group in order to be used for disaggregation for the whole group, such that user feedback may not be required.

In some embodiments, power consumption data analysis system may connect to schedule (or journal) of a particular user in order to retrieve time periods for a set of predetermined events where the power consumption may be changed. For example, retrieving data on a family going on a trip such that a dedicated energy saving plan may be recommended by the system.

According to some embodiments, power production for instance with renewable energy sources (e.g. with solar panels) may also be taken into account during the analysis. Such analysis may be carried out with additional parameters for ambient conditions (e.g. wind velocity for wind power, presence of clouds for solar power, etc.) in the proximity of the user. In some embodiments, it may be possible to detect which users produce power by correlating historical data on consumed energy from the electrical grid, by reducing the produced energy from the total consumed energy (for instance dependent on sky brightness and sunset/sunrise times in the case of solar panels). In some embodiments, historic power production may be evaluated, and thereby provide for an individual user a forecast, taking into account private power production in order to evaluate the expected consumption from the electricity grid.

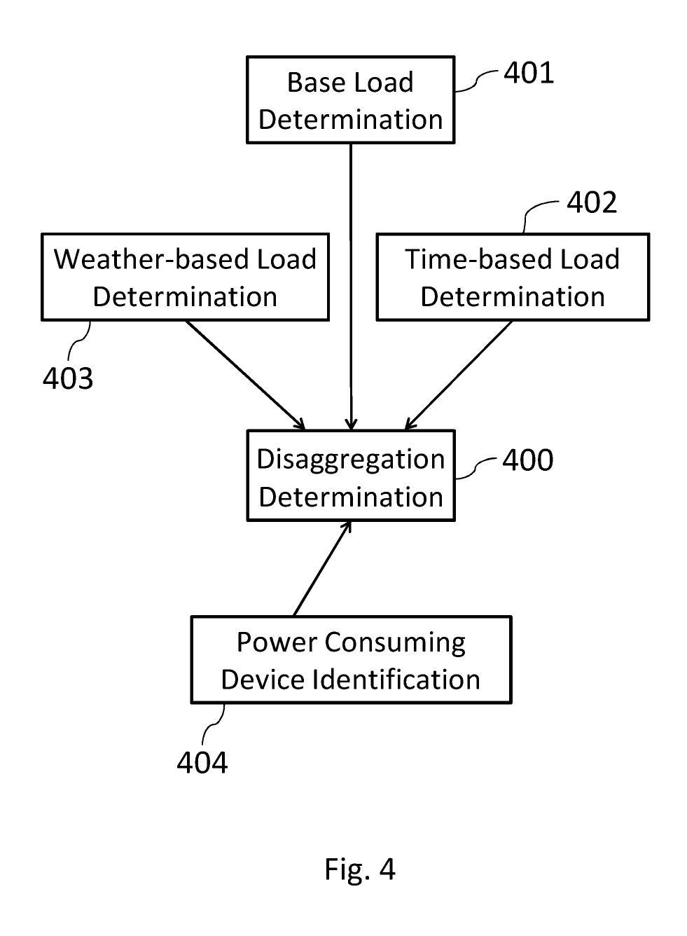

Reference is now made to FIG. 4, which shows a block diagram for determination of disaggregation, according to some embodiments of the invention. In order to determine disaggregation 400 of power consumption data, several processes may be carried out, for instance simultaneously, and analyzed (e.g., by a central processor) so as to determine the disaggregation 400 of the power consumption data.

In some embodiments, at least one base load value may be determined 401 from the power consumption data for at least one consumer, for instance with analysis of daily power consumption clustering history. For example, a consumer having a constant consumption of power due to constant usage (e.g., a refrigerator that constantly consumes power at substantially the same rate) may have a power consumption curve with a corresponding constant base load. In some embodiments, clusters may be created and/or consumers may be grouped based on specific base loads corresponding to consumers with substantially the same rate of constant power consumption. In another example, all branches of a chain of pizzerias (or rival pizzerias) may have the same specific base load (e.g., due to constant usage of specific refrigerators and/or oven of that chain) and thereby grouped together based on the base load determination 401.

In some embodiments, temporal power consumption patterns or a time-based load may be determined 402 from the power consumption data for at least one consumer, for instance using dedicated statistical algorithms (e.g., using the hidden Markov Model) to analyze jumps in power consumption. For example, consumers having a low consumption during the middle of the day (e.g., when most adults are at work) and high consumption during the evenings may have a power consumption curve with peaks at specific times. In some embodiments, clusters may be created and/or consumers may be grouped based on specific time-based load 402 corresponding to consumers with substantially the same rate of power consumption during specific time periods. In another example, some industrial consumers (e.g., bakeries or coffee shops) may have a high consumption during the mornings when particular machines need to be operated.

In some embodiments, periodical power consumption patterns or a weather-based load may be determined 403 from the power consumption data for at least one consumer, for instance using algorithms to detect seasonal (or temperature dependent) power consumption anomalies (e.g., detect an anomaly in a curve of power consumption over time). For example, consumers having low consumption during specific hours (e.g., air-conditioning not working during the night) and high consumption during other hours (e.g., air-conditioning working during the weekend when everybody is at home) may have a power consumption curve with peaks at different times according to changes in the weather and/or temperature. In some embodiments, clusters may be created and/or consumers may be grouped based on specific weather-based load 403 corresponding to consumers with substantially the same rate of power consumption during specific times. In another example, some industrial consumers (e.g., food preparation factories) may have a high consumption during the summer when increased cooling may be required with an increase in ambient temperature.

According to some embodiments, analysis of power consumption data with at least one of base load determination 401, time-based load determination 402 and weather-based load determination 403 may allow determining disaggregation 400 of power consumption data, since the base load may be removed from the total power consumption to determine the disaggregated consumption (e.g., dependent on the weather). In some embodiments, combination of at least two of base load determination 401, time-based load determination 402 and weather-based load determination 403 may allow forecasting of future power consumption.

According to some embodiments, at least one power consuming device may be identified 404 from analysis of power consumption data. Power consumption of some power consuming devices may be recorded (e.g., with a calibrated control group) so that analysis of at least one of historical power consumption data, hardware based training (e.g., calibrating with dedicated hardware to monitor power consumption) and software based training (e.g., determining disaggregated power consumption based on analysis of a control group with known consumption) may allow identification 404 of at least one power consuming device. For example, dedicated hardware (e.g., a computer chip) may be added to a power consuming device (e.g., a cutting machine in a factory) such that average power consumption from that device may be recorded and/or determined. In some embodiments, combination of at least three of base load determination 401, time-based load determination 402, weather-based load determination 403 and identification of at least one power consuming device 403 may allow determining energy saving recommendations based on a comparison of the at least three data sets (e.g., energy saving recommendations to activate a washing machine in the mornings upon determination of washing machine use during the evenings). In some embodiments, with greater separation to different groups and/or clusters and/or affecting factors on power consumption, the accuracy of identifying at least one power consuming device may increase.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of disaggregating power consumption data, the method comprising:
receiving power consumption data from at least one power consumption meter, wherein the received power consumption data corresponds to at least one consumer;
determining power consumption patterns from the received power consumption data;
performing disaggregation of the received power consumption data and identifying at least one base load value for at least one consumer based on the power consumption patterns;
grouping consumers into energetically similar groups based on the disaggregation; and
providing energy saving recommendations to at least one consumer based on the disaggregation and grouping data.

2. The method of claim 1, further comprising:
storing historical power consumption data; and
averaging the grouping data.

3. The method of claim 1, further comprising comparing the energy saving recommendations with a control group.

4. The method of claim 1, further comprising:
receiving feedback from at least one user; and
comparing the received feedback with the recommendation results.

5. The method of claim 1, further comprising grouping consumers into energetically similar groups based on the power consumption patterns, wherein determining energy saving recommendations to at least one consumer is also based on the grouping data.

6. The method of claim 1, further comprising comparing the energy saving recommendations with the received power consumption data.

7. The method of claim 1, wherein the disaggregation is performed based on the type of the received power consumption data.

8. The method of claim 1, wherein the grouping is carried out based on power consumption data.

9. The method of claim 8, wherein the grouping is carried out based on user data including at least one of geographical location, socio-economic status and weather conditions at the proximity of the user.

10. The method of claim 1, wherein energy saving recommendations are based on at least one of weather conditions at the proximity of the user and calendrical data.

11. The method of claim 1, further comprising calibrating power consumption data with known electrical devices that consume power during known periods of time.

12. The method of claim 1, further comprising performing at least one of base load determination, time-based load determination and weather-based load determination.

13. The method of claim 12, further comprising identifying at least one power consuming device.

14. A power consumption data analysis system, the system comprising:
at least one power consumption meter, electrically coupled to a power grid of a premises having at least one power consuming device of at least one consumer; and
an analysis computerized device coupled to the at least one power consumption meter and configured to receive power consumption data corresponding to the at least one consumer, wherein the computerized device comprises a processor and a memory unit that is configured to store code to be processed by the processor,
wherein code executed on the processor is configured to allow:
determination of power consumption patterns;
disaggregation of power consumption data received from the at least one power consumption meter; and
recommendation of energy saving based at least on the disaggregation.

15. The system of claim 14, wherein the analysis computerized device further comprises at least one database having information regarding at least one of: weather conditions, power consumption rates as provided to each consumer, and average power consumption values for a group of consumers in a predefined geographical area.

16. The system of claim 14, wherein the analysis computerized device further comprises at least one database that is configured to store data corresponding to at least two consumers that are grouped based at least on disaggregation results.

17. The system of claim 14, further comprising a communication module configured to allow communication between the at least one power consumption meter and the analysis computerized device.

18. The system of claim 17, wherein the communication between the at least one power consumption meter and the analysis computerized device is at least partially wireless.

19. The system of claim 14, further comprising a user interface module coupled to at least one consumer, wherein the user interface module is configured to receive feedback from a user to be compared with recommendations provided by the processor.
